(19) United States
(12) Patent Application Publication
(10) Pub. No.: US 2024/0363938 A1
(43) Pub. Date: Oct. 31, 2024

(54) Battery Holder

(71) Applicant: Richard K. Rogers, Palos Hills, IL (US)

(72) Inventor: Richard K. Rogers, Palos Hills, IL (US)

(21) Appl. No.: 18/141,350

(22) Filed: Apr. 28, 2023

(51) Int. Cl. H01M 50/216; H01M 50/269; H01M 50/296

(52) U.S. Cl. CPC H01M 50/216; H01M 50/269; H01M 50/296

(57) ABSTRACT

A battery holder includes a housing and a first cylindrical holder and a second cylindrical holder disposed inside the housing. A first electrical terminal and a second electrical terminal are disposed on an outer surface of the housing. A first electrical conductor is configured to provide a first electrical connection between the first electrical terminal and a first electrical contact inside the first cylindrical holder. A second electrical conductor is configured to provide a second electrical connection between the second electrical terminal and a second electrical contact inside the second cylindrical holder. A cover couples to the housing. A third electrical conductor is disposed on first surface of the cover, wherein the third electrical conductor extends from an area above the first electrical contact to an area above the second electrical contact.

### FIELD

The present disclosure relates to battery holders. In particular, the present disclosure relates to battery holders for multiple batteries.

### BACKGROUND

Some electrical devices are designed for specific voltage and current values, often provided by a battery. These devices may provide a different response if the voltage or current are changed. For example, active pickups for an electrical guitar may reduce noise, improve tonal response, and adjusted distortion.

Apparatus and methods for providing adjusted voltage and current values are desirable.

### SUMMARY

A battery holder includes a housing and a first cylindrical holder and a second cylindrical holder inside the housing. A first electrical terminal and a second electrical terminal are disposed on an outer surface of the housing. A first electrical conductor is configured to provide a first electrical connection between the first electrical terminal and a first electrical contact inside the first cylindrical holder. A second electrical conductor is configured to provide a second electrical connection between the second electrical terminal and a second electrical contact inside the second cylindrical holder. A cover couples to the housing. A third electrical conductor is disposed on first surface of the cover, wherein the third electrical conductor extends from an area above the first electrical contact to an area above the second electrical contact.

### BRIEF DESCRIPTION OF THE DRAWINGS

FIG. 1 illustrates a battery holder with batteries in accordance with at least one embodiment.

FIG. 2 illustrates a top view of a housing in accordance with at least one embodiment.

FIG. 3 illustrates a perspective view of a housing and a cover in accordance with at least one embodiment.

FIG. 4 illustrates an alternative perspective view of a housing and a cover in accordance with at least one embodiment.

FIG. 5 illustrates a side view of a shorter edge of a cover for a housing in accordance with at least one embodiment.

FIG. 6 illustrates a side view of a longer edge of a cover for a housing in accordance with at least one embodiment.

FIG. 7 illustrates a bottom view of a coin cell battery in accordance with at least one embodiment.

FIG. 8 illustrates a side view of a coin cell battery in accordance with at least one embodiment.

FIG. 9 illustrates a schematic showing a switch between a serial and a parallel battery arrangement in accordance with at least one embodiment.

FIG. 10 illustrates a battery holder disposed in a cavity of an electronic device in accordance with at least one embodiment.

FIG. 11 illustrates an edge view of a housing in accordance with at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments herein.

The apparatus and method components have been represented where appropriate by conventional symbols in the drawings, showing only those specific details that are pertinent to understanding the embodiments of the present embodiments so as not to obscure the disclosure with details that will be readily apparent to those of ordinary skill in the art having the benefit of the description herein.

### DETAILED DESCRIPTION

The present description discloses apparatus and methods for providing adjusted voltage and current values. A battery holder disposable in an electronic device includes terminals compatible with a standard battery form, such as a 9-volt battery. The battery holder includes electrical conductors configured to connect a plurality of coin cell batteries in series to provide an alternative voltage across the terminals, for example 18 volts, 24 volts, or any other appropriate voltage. Alternatively, the plurality of coin cell batteries may be switched into a series-parallel arrangement to provide 9 volts across the terminals.

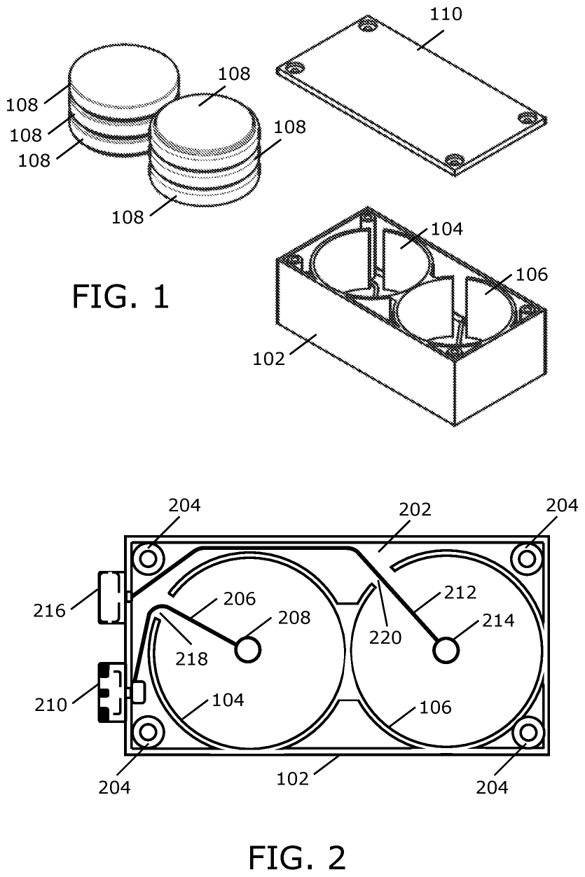

A battery holder with batteries in accordance with at least one embodiment is illustrated in FIG. 1. A housing 102 includes a first cylindrical holder 104 and a second cylindrical holder 106. The first cylindrical holder 104 may be advantageously located adjacent to the second cylindrical holder 106, for example to save space or reduce conductor lengths. The first cylindrical holder 104 and the second cylindrical holder 106 may each be configured to hold three stacked batteries 108, such as coin cell batteries. Alternatively, the first cylindrical holder 104 and the second cylindrical holder 106 may each be configured to hold two, three, four, or more stacked batteries 108, such as coin cell batteries. The batteries of each stack are advantageously stacked electrically in series, for example, a positive terminal of a first battery touches a negative terminal of a second battery, and the positive terminal of the second battery touches a negative terminal of a third battery.

A top view of a housing in accordance with at least one embodiment is illustrated in FIG. 2. The battery holder includes a housing 102. The first cylindrical holder 104 and the second cylindrical holder 106 may be disposed on a first inner surface 202 inside the housing 102. The housing 102 includes a plurality of cylinders 204 configured to receive fasteners such as screws that hold the cover 110 in place on the housing 102.

A first electrical terminal 210 and a second electrical terminal 216 are shown disposed on an outer surface of the housing 102. Optionally, the first electrical terminal 210 and a second electrical terminal 216 may be attached to an apparatus, such as a circuit board, that is coupled to the housing 102 through holes disposed in the housing 102. A first electrical conductor 206 is configured to provide a first electrical connection between the first electrical terminal 210 and a first electrical contact 208 inside the first cylindrical holder 104. A second electrical conductor 212 is configured to provide a second electrical connection between the second electrical terminal 216 and a second electrical contact 214 inside the second cylindrical holder 106. The first electrical conductor 206 and the second electrical conductor 212 may comprise electrically conductive traces disposed on one or more inner surfaces of the housing 102, such as the first inner surface 202.

Alternatively, the first electrical conductor 206 and the second electrical conductor 212 may comprise individual electrically conductive strips or wires optionally covered by electrical insulation such as plastic, or other electrical conductors as known in the industry. Alternatively, the first electrical conductor 206 may extend through a first slot 218 disposed in a wall of the first cylindrical holder 104, and the second electrical conductor 212 may extend through a second slot 220 disposed in a wall of the second cylindrical holder 106. The first electrical terminal 210 and the second electrical terminal 216 extend through the housing 102 to accommodate electrical connection to the first electrical conductor 206 and the second electrical conductor 212, respectively.

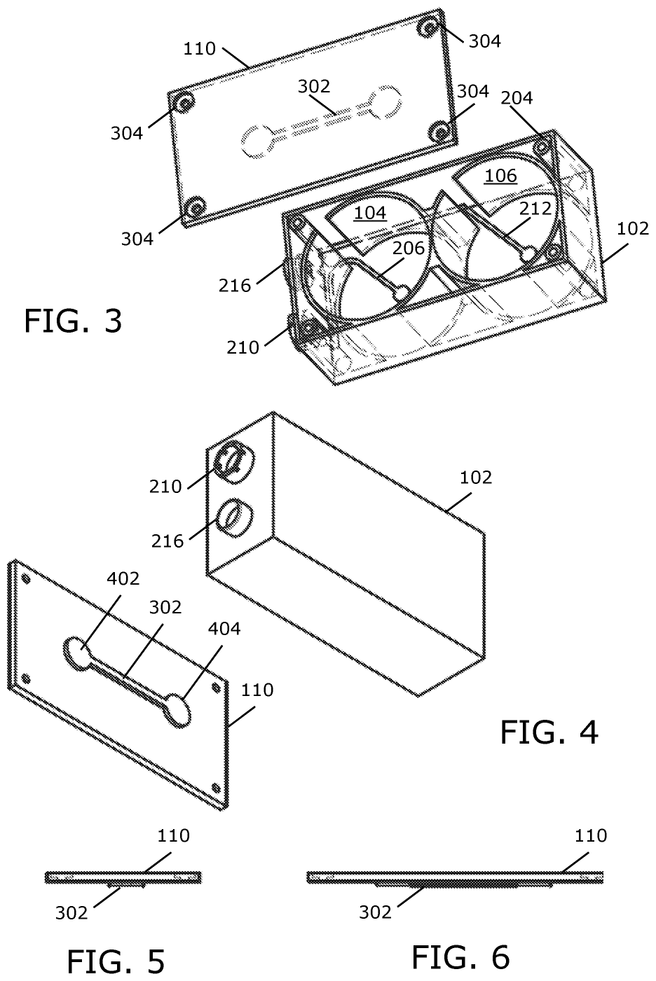

A perspective view of a housing and a cover in accordance with at least one embodiment is illustrated in FIG. 3. A third electrical conductor 302 is disposed on first surface of the cover 110. The third electrical conductor 302 extends from an area above the first electrical contact 208 to an area above the second electrical contact 214. The cover 110 is advantageously coupled to the housing 102 opposite to the first inner surface 202 of the housing 102. A plurality of holes 304 are disposed in the cover 110. Fasteners such as screws (not shown) are inserted through the holes 304 and into the cylinders 204 of the housing 102 such that the cover 110 is securely fastened to the housing 102. The first surface of the cover 110 is inside the housing 102 when the cover 110 is coupled to the housing 102. The first electrical contact 208 and the second electrical contact 214 are configured to compress a first plurality of batteries 108 disposed in series in the first cylindrical holder 104 and a second plurality of batteries 108 disposed in series in the second cylindrical holder 106. For example, the first electrical contact 208 and the second electrical contact 214 may be spring-loaded or otherwise configured to hold each plurality of batteries 108 in contact with each other and with the contacts 402, 404 of the third electrical conductor 302. Optionally, the first electrical contact 208, the second electrical contact 214, and/or the contacts 402, 404 of the third electrical conductor 302 may be spring-loaded in such a way that the contacts facilitate holding different quantities of batteries in each cylindrical holder 104, 108. The contacts 208, 214, 402, 404 may be, for example, spring-loaded metal strips bent at an angle such that the metal strips compress or compact while maintaining electrical connection to the battery 108. Alternatively, the contacts 208, 214, 402, 404 may be electrically conductive springs. For example, a cylindrical holder 104, 108 may hold two batteries 108 in series electrically by the contacts 208, 214, 402, 404 taking up the space where a third battery may fit, and the same cylindrical holder 104, 108 may hold three batteries 108 in series electrically by compressing one or more of the contacts 208, 214, 402, 404. In another example, a cylindrical holder 104, 108 may hold three batteries 108 in series electrically by the contacts 208, 214, 402, 404 taking up the space where a fourth battery 108 may fit, and the same cylindrical holder 104, 108 may hold four batteries 108 in series electrically by compressing one or more of the contacts 208, 214, 402, 404. When a first plurality of batteries 108 is disposed in series electrically in the first cylindrical holder 104 and a second plurality of batteries 108 is disposed in series electrically in the second cylindrical holder 108, the first plurality of batteries and the second plurality of batteries are electrically connected in series by the third electrical conductor 302 disposed on the cover 110 for the housing 102, when the cover 110 is fastened to the housing 102.

An alternative perspective view of a housing and a cover in accordance with at least one embodiment is illustrated in FIG. 4. The first electrical terminal 210 and the second electrical terminal 216 are physically and electrically configured to be compatible with standard 9-volt battery terminals, as known in the industry. A standard 9-volt size battery typically provides a nominal voltage of 9 volts and includes two polarized snap connectors or terminals on one surface. For example, the first electrical terminal 210 and the second electrical terminal 216 may have the same or similar size, shape, and spacing as the terminals on a standard 9-volt battery.

A standard 9-volt battery, which may be referred to as a transistor or portable radio battery, includes, for example, batteries having a form factor or size in conformance with Power Pack 3 (PP3), IEC 6F22, or ANSI/NEDA 1604 specifications. A standard 9-volt battery may include alkaline, lithium, or other types of disposable cells or rechargeable cells such as nickel cadmium, lithium ion, or other types of rechargeable cells. The first electrical terminal 210 and the second electrical terminal 216 may be spaced by the same distance as the terminals are spaced on a standard 9-volt battery. As a result, the terminals 210, 216 of the housing 102 advantageously plug into the same connector 1006 that a standard 9-volt battery plugs into, such as the connector for active pickups in an electric guitar. For example, the first electrical terminal 210 may be a negative terminal (−) and the second electrical terminal 216 may be a positive terminal (+). The terminals 210, 216 may comprise snap connectors such as on a standard 9-volt battery, such as a female terminal that is larger, pronged in a hexagonal (6 prongs) or octagonal shape (8 prongs), and electrically negative and a male terminal that is smaller, circular, and electrically positive, such as shown in more detail in FIG. 11.

The third electrical conductor 302 is disposed on one surface of the cover 110. The third electrical conductor 302 may be spring-loaded to compress a first plurality of batteries 108 disposed in series in the first cylindrical holder 104 and a second plurality of batteries 108 disposed in series in the second cylindrical holder 106. When the cover 110 is fastened to the housing 102, the first plurality of batteries 108 is disposed in series in the first cylindrical holder 104 between the first contact 208 and a third contact 402 of the third electrical conductor 302, and the second plurality of batteries 108 is disposed in series in the second cylindrical holder 106 between the second contact 214 and a fourth contact 404 of the third electrical conductor 302. Thus, the two pluralities of batteries 108 are held electrically in series.

A side view of a shorter edge of a cover for a housing in accordance with at least one embodiment is illustrated in FIG. 5. A side view of a longer edge of a cover for a housing in accordance with at least one embodiment is illustrated in FIG. 6. The third electrical conductor 302 is disposed on one surface the cover 110.

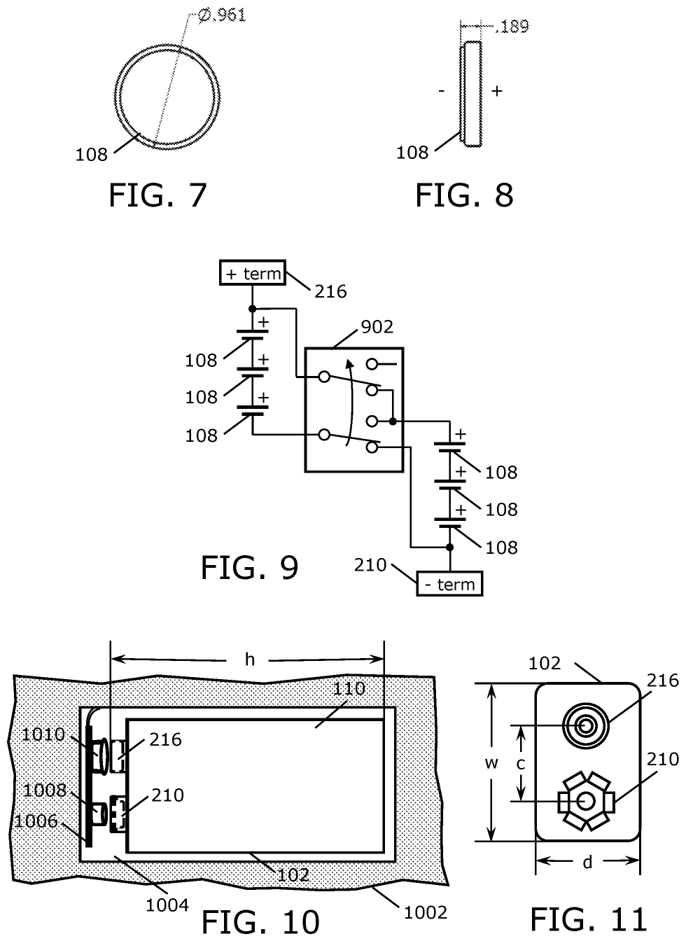

A bottom view of a coin cell battery 108 in accordance with at least one embodiment is illustrated in FIG. 7. The coin cell battery 108 may be, for example, a 3-volt nominal lithium coin cell battery, such as a CR2450 battery. The outer diameter of the coin cell battery 108 may be, for example 0.961 inches nominally. A side view of a coin cell battery in accordance with at least one embodiment is illustrated in FIG. 8. The outer thickness of the coin cell battery 108 may be, for example 0.189 inches nominally. The outer battery housing is shown with two concentric cylindrical sections, including a negative terminal on the outer surface of the smaller section and a positive terminal on the outer surface of the larger section. The first cylindrical holder 104 and the second cylindrical holder 106 are each configured to hold, for example, three 3-volt coin cell batteries in series electrically, such that when six 3-volt coin cell batteries are disposed in the housing in series, 18 volts are provided across the first electrical terminal 210 and the second electrical terminal 216. The coin cell batteries may be, for example, lithium batteries. Thus, 18 volts may be provided within the same form factor as a standard 9-volt battery. Alternatively, the cylindrical holders 104, 106 may each be configured to hold, for example, four 3-volt coin cell batteries in series electrically, such that when eight 3-volt coin cell batteries are disposed in the housing in series, 24 volts are provided across the first electrical terminal 210 and the second electrical terminal 216.

A schematic showing an optional switch between a serial and a parallel battery arrangement in accordance with at least one embodiment is illustrated in FIG. 9. A switch 902 may be provided to switch two stacks of serially connected batteries 108 between serial connection, for a total of 18 volts for three 3-volt cell batteries, and a parallel connection, for a total of 9 volts for three 3-volt cell batteries. The switch 902 may be, for example, a double-pole, double throw (DPDT) switch. Each stack may alternatively include four 3-volt cell batteries. Additional or modified electrical conductors to the electrical conductors in FIG. 2, FIG. 3, and FIG. 4 may be utilized to implement the embodiment of FIG. 9. When the switch 902 is in a first position, when a first plurality of batteries 108 is disposed in series electrically in the first cylindrical holder 104 and a second plurality of batteries 108 is disposed in series electrically in the second cylindrical holder 106, the first plurality of batteries 108 and the second plurality of batteries 108 are electrically connected in series. When the switch 902 is in a second position, such as shown in FIG. 9, when the first plurality of batteries 108 is disposed in series electrically in the first cylindrical holder 104 and the second plurality of batteries 108 is disposed in series electrically in the second cylindrical holder 106, the first plurality of batteries 108 and the second plurality of batteries 108 are electrically connected in parallel. The series connection of the two pluralities of batteries results in twice the voltage of a single plurality of batteries 108 across the positive terminal 216 and negative terminal 210. The parallel connection of the two pluralities of batteries results in the same voltage of a single plurality of batteries 108 across the positive terminal 216 and negative terminal 210, but the batteries will last longer in parallel than a single plurality of batteries.

A battery holder disposed in a cavity of an electronic device in accordance with at least one embodiment is illustrated in FIG. 10. The battery holder, including the housing 102 and cover 110, is shown disposed in an electronic device 1002, such as a musical instrument, for example, an electric guitar or bass that utilizes active pickups. A cavity 1004 is disposed in the electronic device 1002 and is sufficient in size to fit the form factor of a standard 9-volt battery. The battery holder is advantageously configured with a form factor compatible with a standard 9-volt battery form factor. Because the battery holder has a similar form factor as a 9-volt battery, the battery holder, including the housing 102 and cover 110, fits within the cavity 1004 and couples to the battery connector 1006 of the electronic device 1002. The first terminal 210 of the battery holder couples to a first snap connector 1008 of the battery connector 1006. The snap connectors of the battery connector 1006 and terminals of a standard 9-volt battery are shaped such that mechanical connection is possible in only one configuration. The terminals 210, 216 of the housing 102 are shaped such that mechanical connection is possible in only one configuration with the snap connectors of the battery connector 1006. For example, the series of prongs on the first terminal 210 engage with its mating terminal 1008 of the battery connector 1006. The second terminal 216 of the battery holder couples to a second snap connector 1010 of the battery connector 1006. A standard 9-volt battery typically has a length or height that is approximately 46.5 mm to 48.5 mm from end to end including the terminals. The housing 102 advantageously has a length or height h that is approximately 46.5 mm to 48.5 mm to facilitate fitting within the cavity 1004.

An edge view of a housing in accordance with at least one embodiment is illustrated in FIG. 11. The center of the first terminal 210 of the battery holder is spaced by a distance c from the center of the second terminal 216 of the battery holder. The centers of the terminals of a standard 9-volt battery are typically spaced by approximately 12.45 mm to 12.95 mm. The centers of the terminals 210, 216 of the housing 102 are advantageously spaced by approximately 12.45 mm to 12.95 mm to facilitate mating with the battery connector 1006 of the electronic device 1002. A standard 9-volt battery typically has a width that is approximately 24.5 mm to 26.5 mm. The housing 102 advantageously has a width w that is approximately 24.5 mm to 26.5 mm to facilitate fitting within the cavity 1004. A standard 9-volt battery typically has a depth that is approximately 15.5 mm to 17.5 mm. The housing 102 advantageously has a depth d that is approximately 15.5 mm to 17.5 mm to facilitate fitting within the cavity 1004.

The battery housing described above provides many advantages over other methods and apparatus for modifying voltage for an electronic device. For example, placing two 9-volt batteries in series requires hollowing out the cavity in the electronic device as well as adding wires to electrically connect the two 9-volt batteries in series in addition to the battery connector 1006. Other solutions only provide for two cell batteries, not six cell batteries, and are unable to provide the desired voltage. Lithium batteries last longer than alkaline batteries and with slower discharge. The battery housing described above plugs into the battery connector 1006 of the electronic device without need for modification. Thus, the battery housing is a direct substitute for a 9-volt battery that provides 18 volts without electrical or physical modification of the electronic device, such as an electric guitar, in which the battery housing is disposed. Alternatively, 24 volts or other voltages may be provided.

A battery holder includes a housing and a first cylindrical holder and a second cylindrical holder disposed inside the housing. A first electrical terminal and a second electrical terminal are disposed on an outer surface of the housing. A first electrical conductor is configured to provide a first electrical connection between the first electrical terminal and a first electrical contact inside the first cylindrical holder. A second electrical conductor is configured to provide a second electrical connection between the second electrical terminal and a second electrical contact inside the second cylindrical holder. A cover couples to the housing. A third electrical conductor is disposed on first surface of the cover, wherein the third electrical conductor extends from an area above the first electrical contact to an area above the second electrical contact.

Optionally, when a first plurality of batteries is disposed in series electrically in the first cylindrical holder and a second plurality of batteries is disposed in series electrically in the second cylindrical holder, the first plurality of batteries and the second plurality of batteries are electrically connected in series by the third electrical conductor. The battery holder may further comprise a switch, wherein, when the switch is in a first position, when a first plurality of batteries is disposed in series electrically in the first cylindrical holder and a second plurality of batteries is disposed in series electrically in the second cylindrical holder, the first plurality of batteries and the second plurality of batteries are electrically connected in series; and when the switch is in a second position, when the first plurality of batteries is disposed in series electrically in the first cylindrical holder and the second plurality of batteries is disposed in series electrically in the second cylindrical holder, the first plurality of batteries and the second plurality of batteries are electrically connected in parallel. The first electrical terminal and the second electrical terminal may be physically and electrically configured to be compatible with standard 9-volt battery terminals. The battery holder may be configured with a form factor compatible with a standard 9-volt battery form factor. The third electrical conductor may be spring-loaded to compress a first plurality of batteries disposed in series in the first cylindrical holder and a second plurality of batteries disposed in series in the second cylindrical holder. The first electrical contact and the second electrical contact may be spring-loaded to compress a first plurality of batteries disposed in series in the first cylindrical holder and a second plurality of batteries disposed in series in the second cylindrical holder. The first cylindrical holder and the second cylindrical holder may each be configured to hold three 3-volt coin cell batteries in series electrically, such that when six 3-volt coin cell batteries are disposed in the housing in series, 18 volts are provided across the first electrical terminal and the second electrical terminal. The first surface of the cover is advantageously inside the housing when the cover is coupled to the housing. The first cylindrical holder is advantageously adjacent to the second cylindrical holder. The first electrical conductor and the second electrical conductor may comprise electrically conductive traces disposed at least partially on the first inner surface of the housing. The first electrical conductor may extend through a first slot disposed in a wall of the first cylindrical holder, and the second electrical conductor may extend through a second slot disposed in a wall of the second cylindrical holder.

The present disclosure may be embodied in other forms without departing from its spirit or essential characteristics. The described embodiments are to be considered as examples, and in all respects are merely illustrative and not restrictive.

What is claimed is:

1. A battery holder comprising:
a housing;
a first cylindrical holder disposed inside the housing;
a second cylindrical holder disposed inside the housing;
a first electrical terminal and a second electrical terminal disposed on an outer surface of the housing;
a first electrical conductor configured to provide a first electrical connection between the first electrical terminal and a first electrical contact inside the first cylindrical holder;
a second electrical conductor configured to provide a second electrical connection between the second electrical terminal and a second electrical contact inside the second cylindrical holder;
a cover coupled to the housing;
a third electrical conductor disposed on a first surface of the cover, wherein the third electrical conductor extends from an area above the first electrical contact to an area above the second electrical contact.

2. The battery holder of claim 1, wherein, when a first plurality of batteries is disposed in series electrically in the first cylindrical holder and a second plurality of batteries is disposed in series electrically in the second cylindrical holder, the first plurality of batteries and the second plurality of batteries are electrically connected in series by the third electrical conductor.

3. The battery holder of claim 1, further comprising a switch, wherein:
when the switch is in a first position, when a first plurality of batteries is disposed in series electrically in the first cylindrical holder and a second plurality of batteries is disposed in series electrically in the second cylindrical holder, the first plurality of batteries and the second plurality of batteries are electrically connected in series; and
when the switch is in a second position, when the first plurality of batteries is disposed in series electrically in the first cylindrical holder and the second plurality of batteries is disposed in series electrically in the second cylindrical holder, the first plurality of batteries and the second plurality of batteries are electrically connected in parallel.

4. The battery holder of claim 1, wherein the first electrical terminal and the second electrical terminal are physically and electrically configured to be compatible with standard 9-volt battery terminals.

5. The battery holder of claim 1, wherein the battery holder is configured with a form factor compatible with a standard 9-volt battery form factor.

6. The battery holder of claim 1, wherein the third electrical conductor is spring-loaded to compress a first plurality of batteries disposed in series in the first cylindrical holder and a second plurality of batteries disposed in series in the second cylindrical holder.

7. The battery holder of claim 1, wherein the first electrical contact and the second electrical contact are spring-loaded to compress a first plurality of batteries disposed in series in the first cylindrical holder and a second plurality of batteries disposed in series in the second cylindrical holder.

8. The battery holder of claim 1, wherein the first cylindrical holder and the second cylindrical holder are each configured to hold three 3-volt coin cell batteries in series electrically, such that when six 3-volt coin cell batteries are disposed in the housing in series, 18 volts are provided across the first electrical terminal and the second electrical terminal.

9. The battery holder of claim 1, wherein when the first surface of the cover is inside the housing when the cover is coupled to the housing.

10. The battery holder of claim 1, wherein the first cylindrical holder is adjacent to the second cylindrical holder.

11. The battery holder of claim 1, wherein the first electrical conductor and the second electrical conductor comprise electrically conductive traces disposed at least partially on the first inner surface of the housing.

12. The battery holder of claim 1, wherein the first electrical conductor extends through a first slot disposed in a wall of the first cylindrical holder, wherein the second electrical conductor extends through a second slot disposed in a wall of the second cylindrical holder.

13. A battery holder comprising:
a housing;
a first cylindrical holder disposed inside the housing;
a second cylindrical holder disposed inside the housing;
a first electrical terminal and a second electrical terminal disposed on an outer surface of the housing;
a first electrical conductor configured to provide a first electrical connection between the first electrical terminal and a first electrical contact inside the first cylindrical holder;
a second electrical conductor configured to provide a second electrical connection between the second electrical terminal and a second electrical contact inside the second cylindrical holder;
a cover coupled to the housing;
a third electrical conductor disposed on a first surface of the cover, wherein the third electrical conductor extends from an area above the first electrical contact to an area above the second electrical contact;
wherein, when a first plurality of batteries is disposed in series electrically in the first cylindrical holder and a second plurality of batteries is disposed in series electrically in the second cylindrical holder, the first plurality of batteries and the second plurality of batteries are electrically connected in series by the third electrical conductor.

14. The battery holder of claim 13, further comprising a switch, wherein:
when the switch is in a first position, when the first plurality of batteries is disposed in series electrically in the first cylindrical holder and the second plurality of batteries is disposed in series electrically in the second cylindrical holder, the first plurality of batteries and the second plurality of batteries are electrically connected in series; and
when the switch is in a second position, when the first plurality of batteries is disposed in series electrically in the first cylindrical holder and the second plurality of batteries is disposed in series electrically in the second cylindrical holder, the first plurality of batteries and the second plurality of batteries are electrically connected in parallel.

15. The battery holder of claim 13, wherein the first electrical terminal and the second electrical terminal are physically and electrically configured to be compatible with standard 9-volt battery terminals.

16. The battery holder of claim 13, wherein the battery holder is configured with a form factor compatible with a standard 9-volt battery form factor.

17. The battery holder of claim 13, wherein the first cylindrical holder and the second cylindrical holder are each configured to hold three 3-volt coin cell batteries in series electrically, such that when six 3-volt coin cell batteries are disposed in the housing in series, 18 volts are provided across the first electrical terminal and the second electrical terminal.

18. A battery holder comprising:
a housing;
a first cylindrical holder disposed inside the housing;
a second cylindrical holder disposed inside the housing;
a first electrical terminal and a second electrical terminal disposed on an outer surface of the housing;
a first electrical conductor configured to provide a first electrical connection between the first electrical terminal and a first electrical contact inside the first cylindrical holder;
a second electrical conductor configured to provide a second electrical connection between the second electrical terminal and a second electrical contact inside the second cylindrical holder;
a cover coupled to the housing;
a third electrical conductor disposed on a first surface of the cover, wherein the third electrical conductor extends from an area above the first electrical contact to an area above the second electrical contact;
a switch electrically coupled to the first electrical conductor and the second electrical conductor, wherein:
when the switch is in a first position, when a first plurality of batteries is disposed in series electrically in the first cylindrical holder and a second plurality of batteries is disposed in series electrically in the second cylindrical holder, the first plurality of batteries and the second plurality of batteries are electrically connected in series; and
when the switch is in a second position, when the first plurality of batteries is disposed in series electrically in the first cylindrical holder and the second plurality of batteries is disposed in series electrically in the second cylindrical holder, the first plurality of batteries and the second plurality of batteries are electrically connected in parallel.

19. The battery holder of claim 18, wherein the first electrical terminal and the second electrical terminal are physically and electrically configured to be compatible with standard 9-volt battery terminals, and wherein the battery holder is configured with a form factor compatible with a standard 9-volt battery form factor.

20. The battery holder of claim 18, wherein the first cylindrical holder and the second cylindrical holder are each configured to hold three 3-volt coin cell batteries in series electrically, such that when six 3-volt coin cell batteries are disposed in the housing in series, 18 volts are provided across the first electrical terminal and the second electrical terminal.
